(19) United States
(12) Patent Application Publication
(10) Pub. No.: US 2005/0060108 A1
(43) Pub. Date: Mar. 17, 2005

(54) Field-measuring system and method supported by PDA

(75) Inventor: Chia-Lin Ku, Taipei City (TW)

Correspondence Address: BACON & THOMAS, PLLC, 625 SLATERS LANE, FOURTH FLOOR, ALEXANDRIA, VA, 22314, US

(73) Assignee: Metal Industries Research & Development Centre, Kaohsiung City (TW)

(21) Appl. No.: 10/780,729

(22) Filed: Feb. 19, 2004

(30) Foreign Application Priority Data
Sep. 16, 2003 (TW) 92125455

(51) Int. Cl. G06F 19/00

(52) U.S. Cl. 702/62

(57) ABSTRACT

The present invention is a field-measuring system and method supported by a PDA (Personal Digital Assistant) at the control processing field, comprising: a plurality of energy converters for sensing the processing variables at the control processing field and outputting the electric signals in response to the processing variables; a processing controller with a multi-port input interface for receiving the electric signals, processing the electric signals based on a single-chip microprocessor, and outputting the digital data corresponding to the processing variables; a personal digital assistant (PDA) for executing a driver to receive the digital data, and displaying the messages related to the processing variables; and a communication interface circuit for transmitting the data to a PDA. The combination of a PDA with a communication protocol technique facilitates the establishment of a real-time system for data retrieval and monitoring at a control processing field. In addition, the present invention improves the safety of the pipeline operation, and monitors the abnormalities of the pipelines around the clock by operating the pipe switch device at the field.

### BACKGROUND OF THE INVENTION

1. Field of the Invention

The present invention relates to a field-measuring system and method, and particularly to a field-measuring system and method supported by a PDA, which is capable of establishing a real-time system for data-retrieval and monitoring, improving the safety of the pipeline operation, and achieving the monitoring purpose of the abnormality of the pipeline by operating a wire switch device on the field.

2. Description of the Related Art

Conventional industrial control devices, including terminal equipments such as flow meters, pressure difference transmitters, thermometers, valve drivers, and the conventional measuring systems, employ widely the analog signal design with measurement range between 4 and 20 mA, wherein the analog signal of 4 mA represents the zero (complete turn-off of the flow), and 20 mA represents the full scale of reading (complete turn-on of the flow). Further, most of the conventional measuring devices employ twisted-pair lines as signal transmission lines, and employ the analog voltage or current signals for transmission. Therefore, when used for remote controlling, the line is susceptible to interference from the external environment, resulting in the delay of reaction and the attenuation of transmitted signals at the cost of control quality. The conventional communication interface uses the technique of RS-485 for data reception and transmission of output control signals in a small distributed control system. Said technique of half-duplex operation of RS-485 requires only one pair of balance-differential signal lines, but its disadvantages includes inability of simultaneous outbound signal transmission involving more than two nodes, otherwise signal overlapping will occur and disturb the normal procession of communication. Moreover, the operation of data acquisition and monitor in most of the devices used in the conventional measuring system is subordinated to the command of a central computer.

In order to improve the conventional measuring system, the U.S. Pat. No. 5,764,891 adopts the FIELDBUS communication protocol and uses I/O to send commands to industrial control device, including terminal equipments such as flow meters, pressure-difference transmitters, thermometers etc. Subsequently, the industrial control devices will be adjusted according to the feedback after receiving the commands. Further, U.S. Pat. No. 6,370,448 also adopts the FIELDBUS communication protocol and uses I/O to send commands to industrial control devices, including terminal equipments such as flow meters, pressure-difference transmitters, thermometers etc. Subsequently, the industrial control devices will be adjusted according to the feedback after receiving the commands and be coupled to the sequential control loop based on the FIELDBUS communication protocol, and then to the communication sequence control loop by the controller based on the Internet communication protocol.

However, although the U.S. Pat. No. 5,764,891 and U.S. Pat. No. 6,370,448 can improve the conventional technologies, the U.S. Pat. No. 5,764,891 adopts the FIELDBUS communication protocol to realize the coupling to the sequential control loop, which merely results in a single loop control circuit; whereas the U.S. Pat. No. 6,370,448 also adopts the FIELDBUS communication protocol in order to be coupled to the sequential control loop. Because the prior art of U.S. Pat. No. 6,370,448 requires a controller to realize the coupling to the communication sequential control loop based on the Internet communication protocol and to employ the design of a computer to acquire and to monitor data it is not available for the member to retrieve real-time data and to monitor on the controlling field. This problem requires to be dealt with.

### SUMMARY OF THE INVENTION

In light of the above mentioned disadvantage of conventional measuring system of the prior art which does not provide real-time data and monitoring to the field, the object of the present invention is to provide a field-measuring system and method supported by a PDA, whereby a real-time system of data receiving and monitoring is established by combining a personal digital assistant (PDA) with the technique of communication protocol, safety improvement of wire operation is achieved, and monitoring of the abnormalities of the pipeline around the clock can be achieved as well by operating the pipeline switch device at the field.

The present invention of field-measuring system supported by a PDA includes a plurality of energy converters which are used to sense the processing variables at the control processing field and to output electric signals in response to the processing variables; a processing controller with a multi-port input interface for receiving said electric signals, processing said electric signals based on a single-chip microprocessor, and outputting digital data corresponding to the processing variables; a personal digital assistant (PDA) for executing a driver to receive the digital data, and for displaying messages related to the processing variables; and a communication interface circuit for transmitting the data from the processing controller to the PDA.

Said energy converter can be a temperature sensor, a pressure sensor, or a flow sensor.

Said processing variables can be a fluid temperature, fluid pressure or fluid flow volume, so as to represent the temperature, pressure difference or flow volume of the pipeline fluid, and provide the real-time data regarding temperature, pressure or flow volume on the field.

The present invention of the field-measuring control method supported by a PDA is used at a pipeline fluid control field, comprising the following steps: an energy converter is provided for sensing the processing variables at the control processing field, and generating analog signals in response to the processing variables; an analog-to-digital conversion circuit is provided for converting the analog signals into digitalized electric signals; a processing controller is provided for calculating the electric signals and generating data corresponding to the processing variables; a communication interface circuit is provided for transmitting the data to a PDA; and a PDA with a driver installed is provided to receive the data and display the messages related to the processing variables.

The present invention of field-measuring system supported by a PDA, combines a PDA and communication protocol technique to be deployed in a control processing field, and uses the PDA to execute a driver for receiving the electric signal for the sensed processing variables and outputs digital data corresponding to the processing variables, so as to establish a real-time system for data receiving and control management on the field, improve the safety of the pipeline operation, and monitor the abnormalities of the pipeline around the clock by operating the switch device of the pipeline at the field.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 is a schematic diagram of the field-measuring system supported by a PDA according to the present invention.

FIG. 2 is a block diagram of the field-measuring system supported by a PDA according to the present invention.

### DETAILED DESCRIPTION OF THE PREFERRED EMBODIMENT

The following is a detailed description of the best presently known modes of carrying out the inventions. This description is not to be taken in a limiting sense, but is made merely for the purpose of illustrating the general principles of the inventions.

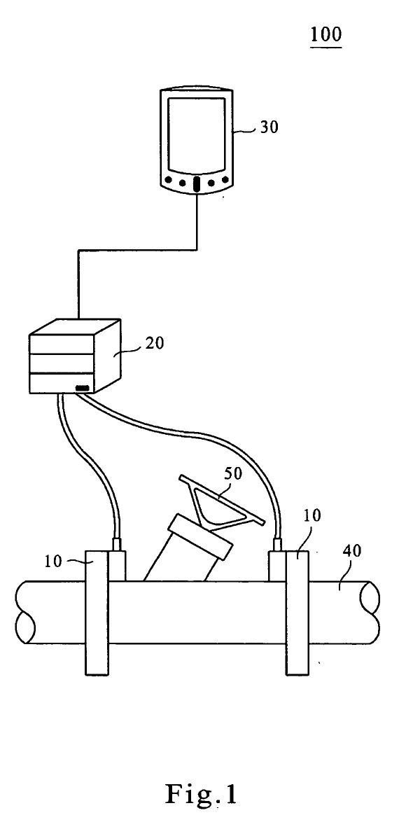

FIG. 1 is a schematic diagram showing the field-measuring system supported by a PDA according to the present invention that is applied at a control-processing field. The present invention of the field-measuring system supported by a PDA 100 includes: a plurality of energy converters 10, which are used for sensing the processing variables at the control processing field and outputting the electric signals in response to the processing variables; a processing controller 20 with a multi-port input interface for receiving said electric signals, processing the electric signals based on a single-chip microprocessor, and outputting the digital data corresponding to said processing variables; a personal digital assistant (PDA) 30 for executing a driver to receive said digital data, and display the messages related to the processing variables; and a communication interface circuit for transmitting the data from the processing controller 20 to the PDA 30, wherein the driver executed by the PDA 30 can communicate with the processing controller 20, and receive the digital data through the communication interface, and display said digital data on the screen of the PDA 30.

Next with reference to FIG. 1, the energy converter 10 is disposed on the pipeline fluid 40 which requires to be measured so as to sense the processing variables therein, and to output electric signals in response to said processing variables, and then transmit said electric signals to said processing controller 20. The multi-port input interface of said processing controller 20 receives said electric signals, processes said electric signals, and outputs the digital data corresponding to said processing variables. Then, said PDA 30 executes a driver, and a communication interface transmits said digital data from said processing controller 20 to said PDA 30, and displays messages related to said processing variables on the screen of said PDA 30, so as to obtain real-time field information, to acquire real-time data at the field and monitor a control valve 50.

In a preferred embodiment of the present invention, said processing variables can be a fluid temperature, fluid pressure, or fluid flow volume so as to obtain the temperature, pressure difference and flow volume of the pipeline fluid and the real-time information at the field.

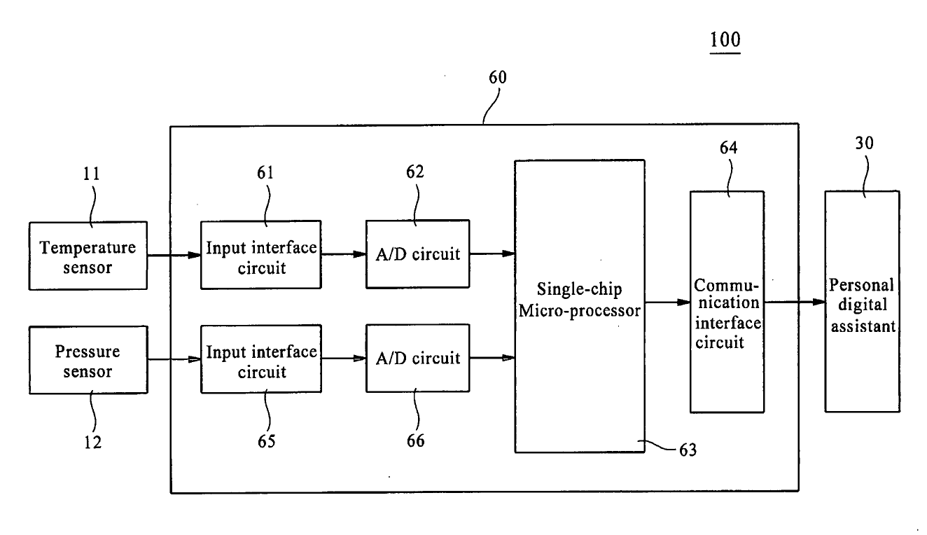

FIG. 2 is a block diagram for the field-measuring system supported by a PDA according to the present invention. The present invention of the field-measuring system supported by a PDA 100 includes: a plurality of energy converters, comprising a temperature sensor 11 and a pressure sensor 12 in a substantive embodiment of the present invention, and said temperature sensor 11 and said pressure sensor 12 are used to collect the temperature and pressure difference of the pipeline fluid; a field-measuring controller 60 which is used to process electric signals of said temperature or pressure of the pipeline fluid sensed by the sensors 11, 12 based on a single-chip microprocessor 63, and to output the corresponding digital data; and a PDA 30, which executes a driver to receive said digital data, and displays messages related to said sensed temperature or pressure.

Continuously referred to FIG. 2, the field-measuring controller 60 includes: a plurality of input interface circuits 61, 65 which are used to receive the analog signal outputted by the sensors 11,12; an analog-to-digital conversion (A/D) circuits 62, 66 for converting the analog signal into the digitalized electric signal; a single-chip microprocessor 63, for receiving the electric signal and outputting the data corresponding to the temperature or pressure sensed by the sensors 11, 12 after undertaking the calculation; and a communication interface circuit 64 for transmitting the data to a PDA 64.

According to an embodiment of the present invention, when an operator is going to adjust the fluid temperature in a pipe at a control processing field, the following steps are undertaken: first, said temperature sensor 11 senses the temperature of a pipeline fluid, and transmits the acquired temperature data to said field-measuring controller 60; next, said input interface circuit 61 of the field-measuring controller 60 receives the analog signal outputted by said temperature sensor 11, then said the analog signal is converted into a digitalized electric signal by using an analog-to-digital conversion circuit 62 and then transmitted to said single-chip microprocessor 63; said single-chip microprocessor 63 receives and processes said electric signal and outputs the data corresponding to said sensed temperature; meanwhile, said PDA 30 executes a driver to prompt said communication interface circuit 64 to transmit the data of output sensed temperature to said PDA 30, so that the PDA 30 displays the data messages related to the temperature, and provides real-time information at the field to facilitate the adjustment of the control valve 50.

According to another embodiment of the present invention, when the operator is going to adjust the fluid pressure of a pipeline at a control processing field, the following steps are undertaken: first, said pressure sensor 12 senses the pressure of a pipeline fluid, and transmits the acquired pressure data to said field-measuring controller 60; next, said input interface circuit 65 of the field-measuring controller 60 receives the analog signal outputted by said pressure sensor 12, then said digital signal is converted into a digitalized electric signal by using an analog-to-digital conversion circuit 66 and then transmitted to a single-chip microprocessor 63; said single-chip microprocessor 63 receives and processes said electric signal and outputs the data corresponding to the sensed pressure; meanwhile, said PDA 30 executes a driver to prompt aid communication interface circuit 64 to transmit the data of outputted sensed pressure to the PDA 30, so that the PDA 30 displays the data messages related to the pressure, and provides real-time information at the field to facilitate the adjustment of the control valve 50.

Said energy converter further includes a flow sensor which is used to sense the flow volume of the pipeline fluid. When the operator is going to adjust the flow volume of a pipeline at a control processing field, the following steps are undertaken: first, said flow sensor senses the flow volume of a pipeline fluid, and transmits said acquired flow volume data to said field-measuring controller; next, said input interface circuit of the field-measuring controller receives the analog signal outputted by said flow sensor, then said digital signal is converted into a digitalized electric signal by using an analog-to-digital conversion circuit and then transmitted to a single-chip microprocessor; said single-chip microprocessor receives and processes said electric signal and outputs the data corresponding to the sensed flow volume; then, the PDA executes a driver to prompt aid communication interface circuit 64 to transmit the data of outputted sensing flow volume to the PDA, so that the PDA displays the data messages related to the pressure, and provides real-time information at the field to facilitate the adjustment of the control valve 50.

The present invention of the field-measuring system supported by a PDA is a field-measuring control method compatible with a PDA used at a pipeline fluid control field, which includes the following steps: an energy converter is provided for sensing processing variables at the control processing field, and generating analog signals in response to said processing variables; an analog-to-digital conversion circuit is provided for converting said analog signals into digitalized electric signals; a processing controller is provided for calculating the electric signals and generating the data corresponded to the processing variables; a communication interface circuit is provided for transmitting the data to a PDA; and a PDA installed with a driver is provided to receive the data and display the messages related to said processing variables.

After the detailed descriptions on the preferred embodiments according to the present invention, the skilled known with the art can appreciate the various changes and modification without departing from the following claims and spirit. And, the present invention is also not limited to the implementation method of the embodiments in the application document.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

1. A field-measuring system used at a control processing field, includes:
a plurality of energy converters for sensing processing variables at the control processing field, and outputting electric signals in response to said processing variables;
a processing controller having a multi-port input interface to receive said electric signals, said processing controller processing said electric signals and outputting digital data corresponding to said processing variables based on a single-chip microprocessor;
a personal digital assistant (PDA) for executing a driver software to receive said digital data and display the messages related to said processing variables; and
a communication interface for transmitting said digital data from said processing controller to said PDA.

2. The field-measuring system according to claim 1, wherein said energy converters include a temperature sensor, pressure sensor or flow sensor.

3. The field-measuring system according to claim 1, wherein said processing variables may be the temperature, pressure or flow volume of a fluid.

4. A field-measuring controller used at a pipeline fluid control field, includes:
a multi-port interface circuit for receiving analog signals outputted by a plurality of energy converters which are used to sense the processing variables at the pipe fluid control field;
an analog-to-digital converter circuit for converting the analog signals into digitalized electric signals;
a single-chip microprocessor for receiving said electric signals and outputting data corresponding to said processing variables;
a communication interface circuit for transmitting the data to a PDA, so that said PDA displays data message related to said processing variables.

5. The field-measuring system according to claim 4, wherein the energy converters are temperature sensors, pressure sensors or flow sensors.

6. The field-measuring system according to claim 4, wherein the processing variables are the temperature, pressure or flow volume of a pipeline fluid.

7. A field-measuring control method used at a pipeline fluid control field, includes the following steps:
processing variables at the control processing field are sensed and analog signals in response to said processing variables are obtained;
said analog signals are converted to digitalized electric signals;
said electric signal are calculated and the data corresponding to said processing variables are obtained;
said data is transmitted to a personal digital assistant; and
said personal digital assistant installed with a driver receives said data and displays messages related to said processing variables.
